(19) United States
(12) Patent Application Publication
(10) Pub. No.: US 2009/0154722 A1
(43) Pub. Date: Jun. 18, 2009

(54) Audio Receiving Device And Method Of Forming Same

(75) Inventors: Chad De Jong, Los Angeles, CA (US); Steven Lane, Orange, CA (US); Oliver Duncan Seil, Pasadena, CA (US); Scott Jackson, Rochester, NY (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/341,890

(22) Filed: Dec. 22, 2008

Related U.S. Application Data
(63) Continuation-in-part of application No. 11/472,098, filed on Jun. 20, 2006.
Application No. 11/472,098 is a continuation-in-part of application No. 11/650,373, filed on Jan. 5, 2007.

(51) Int. Cl. H04B 3/00; H04B 1/00

(52) U.S. Cl. 381/77; 381/119

(57) ABSTRACT

In some embodiments, an audio receiving device can be configured to couple to and produce an output signal for a portable media device. The audio receiving system can include: (a) a first microphone; (b) a second microphone; (c) a housing; and (d) an audio interface configured to electrically couple to the portable media device and provide the output signal to the portable media device. The first microphone can be coupled to the housing such that the first microphone can be rotated relative to the housing. Similarly, the second microphone can be coupled to the housing such that the second microphone can be rotated relative to the housing. Other embodiments are disclosed in this application.

### CROSS-REFERENCE TO RELATED APPLICATIONS

This application is a continuation-in-part of application Ser. No. 11/472,098, entitled Audio Receiving System for a MP3 Player and Method of Forming Same, filed Jun. 20, 2006, and also a continuation-in-part of application Ser. No. 11/650,373, entitled Mixing System for A Portable Media Device, filed Jan. 5, 2007, both of which are incorporated herein by reference.

### FIELD OF THE INVENTION

This invention relates generally to accessories for portable media players, and relates more particularly to audio receiving and/or mixing systems for use with portable media players and methods of forming such systems

### DESCRIPTION OF THE BACKGROUND

Portable media devices are capable of handling digital audio files in one or more file formats. Recently, such devices have become very popular because of their compact size and large storage capacity. Several formats for digital audio files exist, each offering its own combination of sound quality, compression rate, streaming capability, and other features. Some of the existing file formats are: AAC (“advanced audio coding”), ATRAC (“adaptive transform acoustic coding), MP3 (mpeg-1 audio layer 3), AIFF (audio interchange file format), WMA (Windows® media audio), OGG (Ogg Vorbis), and WAV (waveform audio format), but this list is not an exhaustive one. Also, many portable media devices can play back video files in different formats, such as AVI (advanced video interleave) and MPEG-1 (moving picture experts group initial video and audio compression standard). For example, portable media devices sold under the trademark iPod by Apple Computer, Inc. of Cupertino, Calif., are widely sold with this capability. Portable media devices capable of playing different types of digital audio files, and storing them in large numbers, are often referred to as MP3 players because of the popularity of that particular file format.

Traditionally, portable media devices have been able to play back only those audio files uploaded from a computer and stored in the storage system of the portable media device in one of aforementioned file formats. Additionally, until recently, portable media devices have not included mechanisms to allow recording of music or sounds onto the portable media device, nor have they provided support for external audio receiving devices. Newer models of portable media devices such as the iPod® device and other portable media devices, however, provide increased support for external devices, including devices to record sounds onto the portable media device.

Electrical devices have been created that take advantage of some of the recording features of portable media devices, but the capacities of these devices are limited. A user of a portable media device may have an extensive media system. For example, a user may have available to her a media system that may include one or more instruments capable of generating sounds that can be converted into electrical (or audio) signals, such as one or more electric guitars, bass guitars, acoustic guitars, keyboards, microphones, synthesizers, and the like, and/or video signals, such as a video recorder. A user's media system may also include audio and/or video signals recorded on compact discs, digital video discs, records, cassettes, one or more computers, and the like. A user may also have available to her programs that permit manipulation of audio and/or media signals. As an example, these programs can be run on a computer. The number and types of signals that can be input into the devices is limited, and the ability of the devices to permit full integration of the functionalities of a portable media device into a user's media system is limited. Thus, a need exists for an apparatus or system that is capable of permitting a user to integrate the functionalities of one or more portable media devices with one or more components of his or her media system.

### BRIEF DESCRIPTION OF THE DRAWINGS

To facilitate further description of the embodiments, the following drawings are provided in which:

FIG. 1 illustrates a block diagram view of an audio receiving device, according to a first embodiment;

FIG. 2 is a top view illustrating audio receiving device of FIG. 1, according to the first embodiment;

FIG. 3 is a top, front, left isometric view illustrating audio receiving device of FIG. 1, according to the first embodiment;

FIG. 4 is a top, back, right isometric view illustrating audio receiving device of FIG. 1, according to the first embodiment; and

FIG. 5 illustrates a flow chart for an embodiment of a method of forming an audio receiving device configured to couple to and produce an output signal for a portable media device.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant. “Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

In a number of embodiments, an audio receiving device can be configured to couple to and produce an output signal for a portable media device. The audio receiving system can include: (a) a first microphone; (b) a second microphone; (c) a housing; and (d) an audio interface configured to electrically couple to the portable media device and provide the output signal to the portable media device. The first microphone can be coupled to the housing such that the first microphone can be rotated relative to the housing. Similarly, the second microphone can be coupled to the housing such that the second microphone can be rotated relative to the housing.

In other embodiments, a portable mixer can be configured to receive one or more input signals and manipulate the one or more input signals to produce one or more output signals for a portable media device. The portable media device can include a mechanism for recording the one or more output signals and an electrical interface to receive the one or more output signals. The portable mixer can include: (a) a first microphone configured to receive sounds and convert the sounds into one or more first electrical audio signals; (b) a second microphone configured to receive the sounds and convert the sounds into one or more second electrical audio signals; (c) a first electrical input connector configured to receive one or more third electrical audio signals from a media system; (d) a switch electrically coupled to the first microphone, the second microphone, and the first electrical input connector and configured to select as one or more intermediary signals either: (1) the one or more first electrical audio signals and the one or more second electrical audio signals, or (2) the one or more third electrical audio signals; (e) an audio processing component electrically coupled to the switch and configured to manipulate the one or more intermediary signals into the one or more output signals; (f) a control component electrically coupled to the switch and the audio processing component, the control component configured to control the manipulation of the one or more input signals by the audio processing component and to control the selection of the one or more intermediary signals by the switch; (g) a first electrical output connector electrically coupled to the audio processing component and configured to electrically coupled to the electrical interface of the portable media device; (h) a housing at least partially enclosing at least the switch, the audio processing component, and the control component, the housing comprising a first side and a second side. In these embodiments, when the first electrical output connector is coupled to the electrical interface of the portable media device, the first electrical output connector provides the output signal to the portable media device for recordation of the one or more output signals. Furthermore, the first microphone can be coupled to the first side and rotatable relative to the first side. Similarly, the second microphone can be coupled to the second side and rotatable relative to the second side.

Yet another embodiment discloses a method of forming an audio receiving device configured to couple to and produce an output signal for a portable media device. The method includes: (a) providing a housing with a first exterior side and a second exterior side; (b) providing a first microphone; (c) securing the first microphone to the first exterior side of the housing such that the first microphone can be rotated relative to the first exterior side of the housing; (d) providing a second microphone; (e) securing the second microphone to the second exterior side of the housing such that the second microphone can be rotated relative to the second exterior side of the housing; (f) providing an audio processing component; (g) providing a control component; (h) electrically coupling the first microphone and the second microphone to the audio processing component; (i) electrically coupling the control component to the audio processing component; (j) securing the audio processing component and the control component inside the housing; (k) providing an electrical output connector; and (l) electrically coupling the electrical output connector to the audio processing component, where the electrical output connector is configured to be coupled to the portable media device.

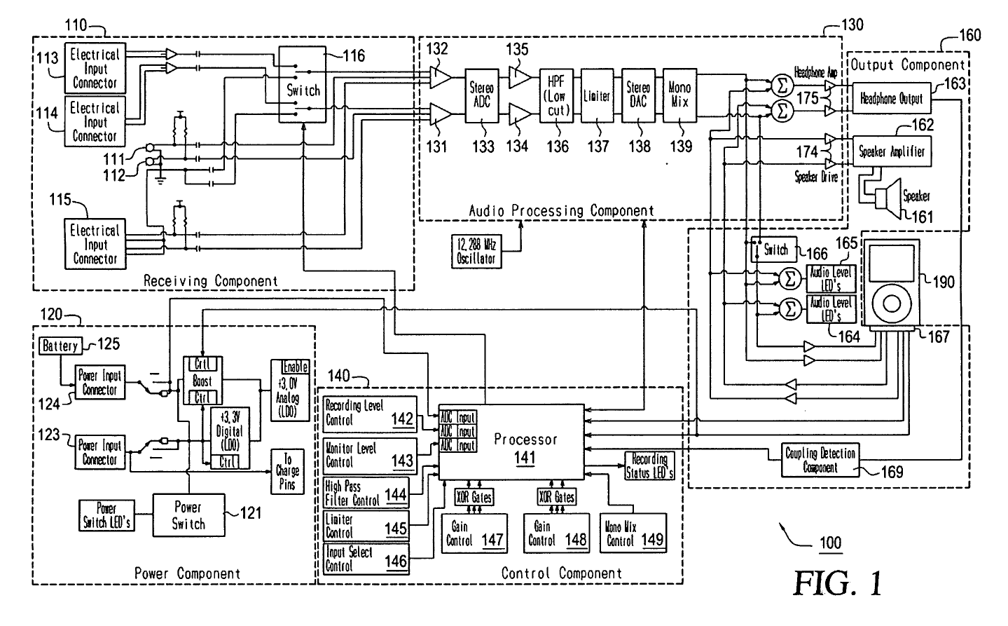

Turning to the drawings, FIG. 1 illustrates a block diagram view of an audio receiving device 100, according to a first embodiment. Audio receiving device 100 is merely exemplary and is not limited to the embodiments presented herein. Audio receiving device 100 can be employed in many different embodiments or examples not specifically depicted or described herein.

In various examples, audio receiving device 100 can be configured to receive one or more input signals and manipulate the one or more input signals to produce one or more output signals for a portable media device 190. Portable media device 190 can include a mechanism (not shown) for recording the one or more output signals and an electrical interface (not shown) to receive the one or more output signal from audio receiving device 100. In the same or different embodiments, audio receiving device 100 is configured to couple to and produce an output signal for portable media device 190. Portable media device 10 is removably coupled to audio recording device 100. It will be understood that portable media device 190 is not necessarily, or need not be, a component of audio receiving device 100, but is merely shown to facilitate understanding of audio receiving device 100 and the way in which it may function.

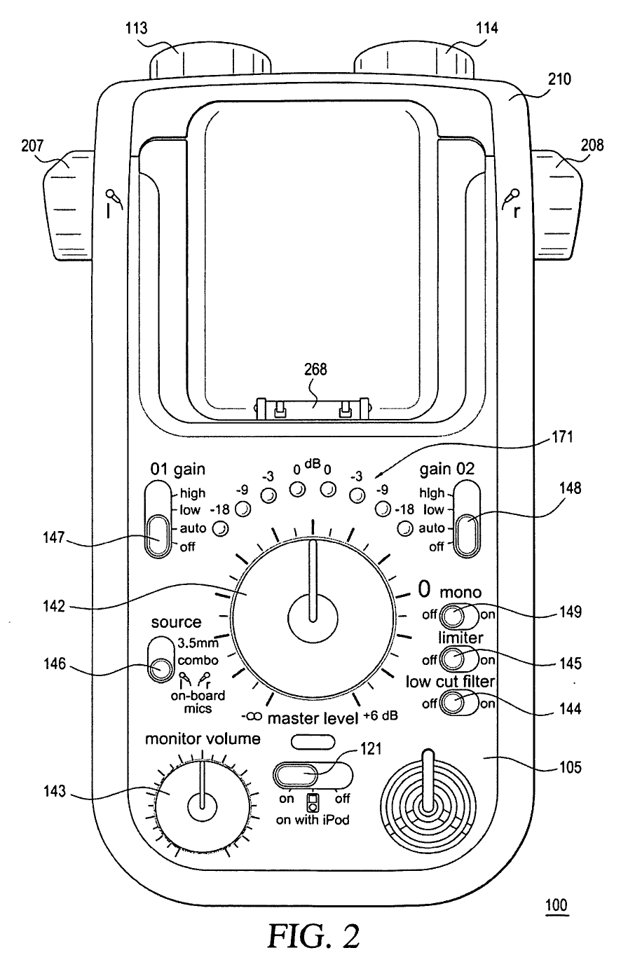

In the same or different embodiments, portable mixer or audio receiving device 100 can include: (a) receiving component 110; (b) a power component 120; (c) an audio processing component 130; (d) a control component 140; and (e) an output component 160. A housing 210 (FIG. 2) can enclose at least a portion of receiving component 110, power component 120, audio processing component 130, the control component 140, and output component 160. In some examples, a part or all of audio processing component 130 and control component 140 can be considered an audio processing mechanism.

Receiving component 110 can include (a) a microphone 111 configured to receive sounds and convert the sounds into a first electrical audio signal; (b) a microphone 112 configured to receive sounds and convert the sounds into a second electrical audio signal; (c) one or more electrical input connectors 113, 114, and 115; and (d) a switch 116.

A microphone is an acoustic to electric transducer that converts sounds into electrical signals, i.e., audio signals. In some embodiments, microphones 111 and 112 are omni-directional microphones. Omi-directional microphones are non-directional microphones having sound responses substantially spherical in three dimensions. Omni-directional microphones can be less sensitive than other types of microphones to low-frequency sounds from sources in close proximity and, thus, can be preferable for use with some MP3 players with hard-disk storage systems. In many situations, the spinning of the hard disk can create a considerable amount of low-frequency noise, which can ruin the quality of the audio recording when using microphones highly sensitive to low-frequency sounds.

In other embodiments, microphones 111 and 112 are uni-directional microphones. Uni-directional microphones differ from omni-directional microphones in that they are more sensitive to sounds from a single direction. Usually, uni-directional microphones are preferable to omni-directional for stereo recording because of their better overall performance. However, uni-direction microphones are sensitive to low-frequency noise from sources in close proximity and, thus, in some situations should not be used with MP3 players with hard-disk storage systems. In various embodiments, uni-direction microphones can be used with MP3 players, which use Random Access Memory (RAM) and other types of static media to store audio files. Other types of microphones can also be used within audio receiving device 100.

In some examples, electrical input connectors 113, 114, and 115 can be configured to receive one or more electrical audio signals from one or more input sources (not shown). In various embodiments, electrical input connectors 113 and 114 can be combination XLR and ¼ inch stereo jacks, and electrical input connector 115 can be a ⅛ inch TSR (Tip, Ring, Sleeve) jack. In other embodiments, electrical input connectors 113, 114, and 115 can be different combinations of electrical input connectors. For example, one or more of electrical input connectors 113, 114, and 115 can be XLR jacks, RCA (Radio Corporation of America) plugs, ¼ inch stereo jack, ⅛ inch TSR jacks, and/or banana jacks. In yet further embodiments, one or more of electrical input connectors 113, 114, and 115 can be video and/or combination audio and video connectors.

Switch 116 can be electrically coupled to microphone 111, microphone 112, and electrical input connector 113 and 114. Switch 116 can be configured to select an input signal from one or more of the electrical signals from microphones 111 and 112 and/or electrical input connectors 113, 114, and 115. Switch 116 electrically couples the one or more selected input signals (i.e., the one or more intermediary signals) to the input of audio processing component 130. In some examples, control component 140 can instruct switch 116 to select a particular one of microphones 111 and 112 and/or electrical input connectors 113, 114, and 115. That is, in some examples, switch 116 selects as the one or more intermediary signal either: (a) the first electrical audio signals and second electrical audio signals from microphones 111 and 112, respectively; (b) one or more third electrical signals from electrical input connectors 113 and 114; or (c) one or more fourth electrical signals from electrical input connector 115. In other embodiments, switch 116 can also be directly electrically coupled to electrical input connector 113, 114, and/or 115 or be configured to select other combinations of electrical input connectors 113, 114, and 115 and microphones 111 and 112.

Audio processing component 130 can be electrically coupled to switch 116, microphones 111 and 112 and electrical input connectors 113, 114, and 115. Audio processing component 130 can be configured to manipulate the one or more intermediary signals into the one or more output signals. In some embodiments, audio processing component 130 can be an audio codec, for example the Wolfson® Microelectronics codec, model number WM8983. In other embodiments, other codecs can be used, or each of the components of audio processing component 130 can be separate and/or discrete electronic circuits.

Audio processing component 130 can include: (a) gain control mechanisms 131 and 132; (b) a stereo analog-to-digital converter (ADC) 133; (c) master levels 134 and 135; (d) a high pass filter (HPF) 136; (e) a limiter 137; (f) a stereo digital-to-analog converter (DAC) 138; and (g) a mono mixer 139. In various examples, a user can control one or more of gain control mechanisms 131 and 132, master levels 134 and 135, high pass filter 136, limiter 137, and mono mixer 139 using control component 140.

In some embodiments, receiving component 110 can receive input signals and communicate electrical signals (i.e., the intermediary signals) on two channels to audio processing component 130. In these embodiments, gain control mechanism 131 can be configured to apply a first gain to a first signal of the one or more of the intermediary signals. Similarly, gain control mechanism 132 can be configured to apply a second gain to a second signal of the one or more of the intermediary signals. Descriptions of the other components of audio processing component 130 are provided below.

In other embodiments, audio receiving device 100 need not to include all of the features/components described above and/or could include additional features/components in use (or used in the future) in audio mixers not included in the illustrated embodiments. Furthermore, audio receiving device 100 can include any number of channels, any of which can be designed to accept mono signals, stereo signals, or both. In addition, audio receiving device 100 can receive and process video signals, either in addition to or exclusive of audio signals.

Control component 140 can be electrically coupled to switch 116 and audio processing component 130. In some embodiments, control component 140 is configured to control the manipulation of the intermediate signal by audio processing component 130 and to control the selection of the one or more intermediary signals by switch 116.

In some embodiments, control component 140 can include various controls. For example, control component 140 can include: (a) a processor 141; (b) a recording level control 142; (c) a monitor level control 143; (d) a high pass filter control 144; (e) a limiter control 145; (f) an input selection control 146; (g) gain controls 147 and 148; and (h) a mono mix control 149.

In some examples, processor 141 can be a microcontroller. For example, processor 141 can be an eight bit microcontroller sold under the trademark PSOC by Cypress of San Jose, Calif., or an eight bit microcontroller sold under the part number C8051F331 or C8051F333 by Silicon Laboratories of Austin, Tex. Processor 141 or control component 140 can further include separate hand shaking (or authentication) logic or circuitry (not shown), if required by portable media device 190.

Recording level control 142 and monitor level control 143 can be potentiometers or other controls. For example, recoding level controls coupled with master levels 134 and 135 permit a user to control the range of the signal flowing out of the volume adjustment mechanism in a range of silent to +6 decibels (dB). Monitor level control 143 coupled with speaker drivers 174 and amplifiers 175 permits a user to control the range of the volume output to electrical output connector 163 and speaker 161. Although rotary potentiometers are shown in the embodiment illustrated in FIG. 2, potentiometers can take other forms such as, for example, sliders.

In some examples, gain controls 147 and 148 can be switches that in combination with gain control mechanisms 131 and 132 permit a user to select a level of gain (e.g., high, low, automatic, or none) for each of the channels or intermediary signals. High pass filter control 144 can be a switch that in combination with high pass filter 136 permits a user to select whether to apply a high pass filter (e.g., a high shelving filter at 12 kHz [kilohertz], +/−12 dB) to one or more intermediary signals or channels. Limiter control 145 can be a switch that in combination with limiter 137 permits a user to select whether to attenuate the peaks in one or more intermediary signals that are above an automatically determined threshold value. Mono mix control 149 can be a switch that in combination with mono mixer 139 permits a user to select a mono output signal.

Input selection control 146 can be a switch that in combination with switch 116 allows the user to select the source of the intermediary signal or channels from microphones 111 and 112 and electrical input connectors 113, 114, and 115. In some examples, input selection control 146 with switch 116 permits the user to select as the intermediary signal: (a) the electrical signals from microphones 111 and 112; (b) the electrical signals from electrical input connector 113 and 114; or (c) the electrical signal(s) from electrical input connector 115.

Output component 160 can provide the output signal from audio processing component 130 to the user and portable media device 190. In some examples, output component 160 can include: (a) speaker 161; (b) a speaker amplifier 162; (c) an electrical output connector 163; (d) a coupling detector component 169; (d) an audio interface or electrical output connector 167; (e) switch 166 coupled to speaker 161 (via speaker amplifier 162), electrical output connector 163, and audio processing component 130; and (f) audio level LEDs (light emitting diodes) 164 and 165.

Speaker 161 can be coupled to speaker drivers 174 through speaker amplifier 162. Output component 160 can be configured to allow a user to listen to the output signal substantially simultaneously with electrical output connector 167 providing the output signal to portable media device 190. In these examples, speaker 161 can allow the user to listen to the output signal substantially simultaneously with electrical output connector 167 providing the output signal to portable media device 190.

Electrical output connector 163 can be coupled to amplifiers 175. Electrical output connector 163 can be configured to provide the one or more output signals to headphones or other hearing devices. In various examples, coupling detector component 169 can detect a coupling of an audio output device (e.g., headphones) to electrical output connector 163 and informs processor 141 of the coupling. Processor 141 can instruct switch 166 to switch the output signal from speaker 161 to electrical output connector 163.

In some examples, electrical output connector 163 can also be configured to allow a user to listen to the output signal substantially simultaneously with electrical output connector 167 providing the output signal to portable media device 190. In another embodiment, switch 166 can permit audio receiving device 100 to output the output signal substantially simultaneously to electrical output connector 163, speaker 161, and electrical output connector 167. In some examples, electrical output connector 163 and/or speaker 161 can be considered an output interface.

Electrical output connector 167 is configured to be electrically coupled to portable media device 190. That is, electrical output connector 167 can be electrically coupled to audio processing component 130 and receive the output signal from audio processing component 130. Electrical output connector 167 can be configured to be electrically coupled to the electrical interface of portable media device 190, when the first electrical output connector 167 is coupled to the electrical interface of portable media device 190. In some examples, electrical output connector 167 provides the output signal to portable media device 190 for recording of the one or more output signals.

Electrical output connector 167 can transfer communication, power and audio signals between audio receiving device 100 and portable media device 190. In various embodiments, electrical output connector 167 includes a connector 268 (FIG. 2). The type of electrical output connector 167 depends on the type of connector that portable media device 190 (or devices) is designed to accept. For example, electrical output connector 167 can include a thirty-pin male serial connector configured to be plugged into and electrically coupled to an iPod® device. In other examples, electrical output connector 167 can be a male USB (universal serial port) connector to couple with a portable media device with a female USB connector.

Power component 120 can provide electrical power to audio receiving device 100. In some examples, power component 120 can include: (a) a power input connector 123 configured to couple to an external source of electrical power (e.g., an alternating current (AC) wall outlet); and (b) a power input connector 124 configured to couple to a battery 125. Power component 120 also can include a power switch 121 that permits the user to turn on or off the electrical power to audio receiving device 100. In some examples, power switch 121 can permit the user to select whether audio receiving device 100 is automatically turned on when portable media device 190 is turned on and coupled to audio receiving device 100.

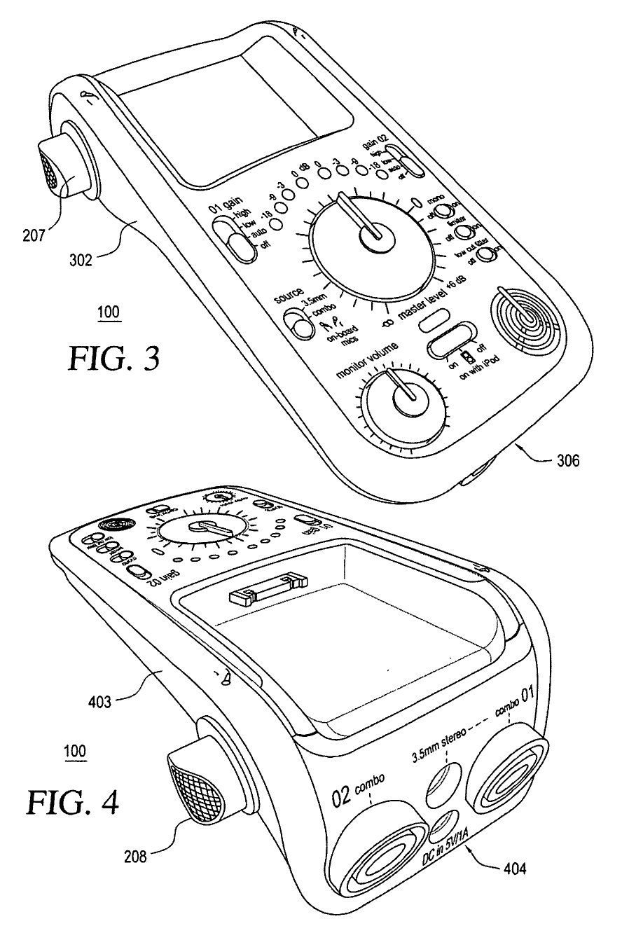

FIG. 2 is a top view illustrating audio receiving device 100, according to the first embodiment. FIG. 3 is a top, front, left isometric view illustrating audio receiving device 100, according to the first embodiment. FIG. 4 is a top, back, right isometric view illustrating audio receiving device 100, according to the first embodiment.

Referring to FIGS. 2, 3, and 4 to show other features of audio receiving device 100, housing 210 can include: (a) a surface or side 302 (FIG. 3); (b) a surface or side 403 (FIG. 4) opposite side 302; (c) a surface or side 404 (FIG. 4) adjacent to sides 302 and 403; (d) a surface or side 105 (FIG. 1) adjacent to sides 302, 403 and 404; (e) a surface or side 306 (FIG. 3) adjacent to sides 302 and 403 and opposite side 404; and (f) a surface or side (not shown) opposite side 105 and adjacent to sides 302, 403, 404, and 306. Housing 210 is merely exemplary and is not limited to the embodiments presented herein. Housing 210 can be employed in many different embodiments or examples not specifically depicted or described herein.

In various examples, microphone 111 is located at side 302, and microphone 112 is located at side 403. In the same or different examples, microphone 111 can be coupled to housing 210 such that microphone 111 can be rotated at least a hundred and fifty degrees around a first axis perpendicular to a portion of side 302. Similarly, microphone 112 can be coupled to housing 210 such that microphone 111 can be rotated at least a hundred and fifty degrees around a second axis parallel to a portion of side 403. In one embodiment, the first and second axes are parallel and/or collinear with each other. For example, microphone 111 can be securely coupled to housing 210 inside of a covering 207 (FIG. 2). Covering 207 and microphone 111 can be rotatably coupled to housing 210. Similarly, microphone 112 can be securely coupled to housing 210 inside of a covering 208 (FIG. 2). Covering 208 and microphone 112 can be rotatably coupled to housing 210.

In other embodiments, microphones 111 and 112 can be secured to other surfaces or sides of housing 210. For example, microphones 111 and 112 could be rotatably coupled to side 404.

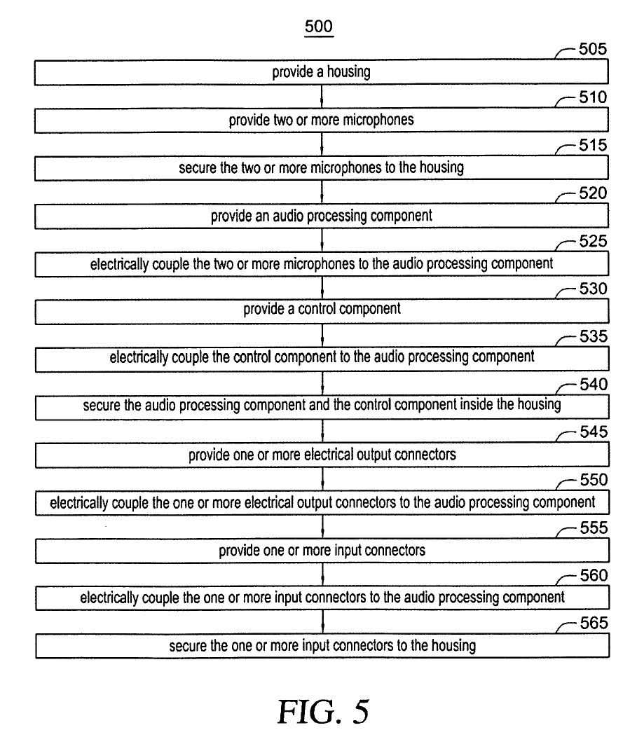

FIG. 5 illustrates a flow chart for an embodiment of a method 500 of forming an audio receiving device configured to couple to and produce an output signal for a portable media device. It should be appreciated that this method is merely illustrative of a technique for implementing the various aspects of certain embodiments described herein, and audio receiving device 100 (FIG. 1) and method 500 are not limited to this particular embodiment, as numerous other embodiments are possible.

Method 500 of FIG. 5 includes an activity 505 of providing a housing. As an example, the housing can be similar or identical to housing 210 of FIG. 2. In some embodiments, providing the housing can include providing the housing with a first exterior side and a second exterior side opposite the first exterior side. For example, the first exterior side and the second exterior side can be identical or similar to side 302 (FIG. 3) and side 403 (FIG. 4), respectively. Subsequently, method 500 of FIG. 5 includes an activity 510 of providing two or more microphones. As an example, the two or more microphones can be identical or similar to microphones 111 and 112 of FIG. 1. In some examples, providing two or more microphones can include: (a) providing a first microphone; and (b) providing a second microphone.

Next, method 500 of FIG. 5 includes an activity 515 of securing one or more microphones to the housing. As an example, the two or more microphones can be secured to the housing similar or identical to the securing of microphones 111 and 112 to housing 210 as illustrated in FIGS. 2, 3, and 4.

In some examples, securing the one or more microphones to the housing can include: (a) securing a first microphone to a first exterior side of the housing; and (b) securing a second microphone to a second exterior side of the housing. As an example, securing the first and second microphone can be similar or identical to securing microphone 111 to side 302 in FIG. 3 and securing microphone 112 to side 403 in FIG. 4, respectively.

In the same or different embodiment, securing the one or more microphones to the housing can include: (a) securing the first microphone to the first exterior side of the housing such that the first microphone can be rotated at least a hundred and fifty degrees in relation to the first side of the housing; and (b) securing the second microphone to the second exterior side of the housing such that the second microphone can be rotated at least a hundred and fifty degrees in relation to the second side of the housing.

Method 500 in FIG. 5 continues with an activity 520 of providing an audio processing component. As an example, the audio processing component can be similar or identical to audio processing component 130 of FIG. 1.

Subsequently, method 500 of FIG. 5 includes an activity 525 of electrically coupling the one or more microphones to the audio processing component. As an example, the one or more microphones can be coupled to the audio processing component similar or identical to the coupling of microphones 111 and 112 to audio processing component 130, as illustrated in FIG. 1.

Next, method 500 of FIG. 5 includes an activity 530 of providing a control component. As an example, the control component can be identical or similar to control component 140 of FIG. 1.

Method 500 of FIG. 5 continues with an activity 535 of electrically coupling the control component to the audio processing component. As an example, the electrical coupling of the control component to the audio processing component can be similar or identical to the electrical coupling of control component 140 to audio processing component 130 as illustrated in FIG. 1.

Subsequently, method 500 of FIG. 5 includes an activity 540 of securing the audio processing component and control component inside the housing. As an example, securing the audio processing component and control component inside the housing can be similar or identical to the securing of audio processing component 130 (FIG. 1) and control component 140 (FIG. 1) inside of housing 210 (FIG. 2).

Next, method 500 of FIG. 5 includes an activity 545 of providing one or more electrical output connectors. In some embodiments, each of the one or more electrical output connectors can be configured to be coupled to one or more portable media devices. As an example, the electrical output connectors can be similar or identical to electrical output connector 167 of FIG. 1.

Method 500 of FIG. 5 continues with an activity 550 of electrically coupling the one or more electrical output connectors to the audio processing component. As an example, the electrical coupling of the one or more electrical output connectors and the audio processing component can be similar or identical to the electrical coupling of electrical output connector 167 and audio processing component 130, as illustrated in FIG. 1.

Subsequently, method 500 of FIG. 5 includes an activity 555 of providing one or more input connectors. As an example, the one or more connectors can be similar or identical to electrical input connectors 113, 114, and/or 115 of FIG. 1. In some embodiments, providing the one or more input connectors can include: (a) providing a first input audio connector; and (b) providing a second input audio connector.

Next, method 500 of FIG. 5 includes an activity 560 of electrically coupling the one or more input connectors to the audio processing component. As an example, the electrical coupling of the one or more electrical input connectors and the audio processing component can be similar or identical to the electrical coupling of electrical input connectors 113, 114, and/or 115 and audio processing component 130, as illustrated in FIG. 1.

In some embodiments, electrically coupling the one or more input connectors to the audio processing component can include: (a) electrically coupling first input connector to the audio processing component; and (b) electrically coupling the second input connector to the audio processing component.

Method 500 of FIG. 5 continues with an activity 565 of securing one or more input connectors to the housing. In some examples, securing the one or more input connectors to the housing can include: (a) securing a first input connector to the housing; and (b) securing a second input connector to the housing. As an example, securing the first and second input connector can be similar or identical to securing electrical input connectors 113, 114, and 115 (FIG. 1) to housing 210 (FIG. 2).

Although the invention has been described with reference to specific embodiments, it will be understood by those skilled in the art that various changes may be made without departing from the spirit or scope of the invention. For example, it will be readily apparent that audio receiving device 100 (FIG. 1) can include other audio procession mechanisms in addition to or instead of the mechanism included in the depicted embodiments of audio processing component 130 (FIG. 1). In another example, a receiving component can include three or more microphones. Furthermore, the activities of method 500 in FIG. 5 can occur in different sequences. For example, activities 525, 535, and 540 in FIG. 5 can occur simultaneously with each other, and the sequence of activities 525, 535, 550, and 560 can be reversed. Also, in other embodiments, microphones 111 and 112 and their respective covers 207 and 208 can rotate more or less than one hundred fifty degrees. Additional examples of such changes have been given in the foregoing description. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the devices, apparatuses, systems and methods discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An audio receiving device configured to couple to and produce an output signal for a portable media device, the audio receiving system comprising:
a first microphone;
a second microphone;
a housing; and
an audio interface configured to electrically couple to the portable media device and provide the output signal to the portable media device;
wherein:
the first microphone is coupled to the housing such that the first microphone can be rotated relative to the housing; and
the second microphone is coupled to the housing such that the second microphone can be rotated relative to the housing.

2. The audio receiving device of claim 1, wherein:
the housing has a first surface and a second surface opposite the first surface;
the first microphone is located at the first surface of the housing; and
the second microphone is located at the second surface of the housing.

3. The audio receiving device of claim 1, wherein:
the first microphone is coupled to the housing such that the first microphone can be rotated relative to the first surface of the housing; and
the second microphone is coupled to the housing such that the second microphone can be rotated relative to the second surface of the housing.

4. The audio receiving device of claim 1, wherein:
the first microphone coupled to the housing such that the first microphone can be rotated at least a hundred and fifty degrees around a first axis substantially perpendicular to the first surface of the housing; and
the second microphone coupled to the housing such that the second microphone can be rotated at least a hundred and fifty degrees around a second axis substantially perpendicular to the second surface of the housing.

5. The audio receiving device of claim 1, further comprising:
an audio processing mechanism electrically coupled to the first microphone, the second microphone, and the audio interface.

6. The audio receiving device of claim 5, wherein:
the audio processing mechanism comprises:
an audio codec electrically coupled to the first microphone, the second microphone, and the audio interface; and
a microcontroller electrically coupled to the codec and configured to control the codec.

7. The audio receiving device of claim 1, further comprising:
a first input connector configured to electrically couple to a first input source and receive a first input signal from the input source.

8. The audio receiving device of claim 7, wherein:
the first input connector is an XLR connector.

9. The audio receiving device of claim 7, further comprising:
a second input connector configured to electrically couple to a second input source and receive a second input signal from the second input source.

10. The audio receiving device of claim 1, further comprising:
an output interface configured to allow a user to listen to the output signal substantially simultaneously with the audio interface providing the output signal to the portable media device.

11. The audio receiving device of claim 1, wherein:
the first and second microphones are unidirectional microphones.

12. A portable mixer configured to receive one or more input signals and manipulate the one or more input signals to produce one or more output signals for a portable media device, the portable media device includes a mechanism for recording the one or more output signals and an electrical interface to receive the one or more output signals, the portable mixer comprising:
a first microphone configured to receive sounds and convert the sounds into one or more first electrical audio signals;
a second microphone configured to receive the sounds and convert the sounds into one or more second electrical audio signals;
a first electrical input connector configured to receive one or more third electrical audio signals from a media system;
a switch electrically coupled to the first microphone, the second microphone, and the first electrical input connector and configured to select as one or more intermediary signals either: (a) the one or more first electrical audio signals and the one or more second electrical audio signals, or (b) the one or more third electrical audio signals;
an audio processing component electrically coupled to the switch and configured to manipulate the one or more intermediary signals into the one or more output signals;
a control component electrically coupled to the switch and the audio processing component, the control component configured to control the manipulation of the one or more input signals by the audio processing component and to control the selection of the one or more intermediary signals by the switch;
a first electrical output connector electrically coupled to the audio processing component and configured to electrically coupled to the electrical interface of the portable media device;
a housing at least partially enclosing at least the switch, the audio processing component, and the control component, the housing comprising a first side and a second side,
wherein:
when the first electrical output connector is coupled to the electrical interface of the portable media device, the first electrical output connector provides the output signal to the portable media device for recordation of the one or more output signals;
the first microphone is coupled to the first side and rotatable relative to the first side;
the second microphone is coupled to the second side and rotatable relative to the second side;
the one or more input signals comprise the sounds and the one or more third electrical signals.

13. The portable mixer of claim 12, further comprising:
a second electrical input connector electrically coupled to the switch and configured to receive one or more fourth electrical audio signals from the media system,
wherein:
the switch is configured to select as the one or more intermediary signal: (a) the one or more first electrical audio signals and the one ore more second electrical audio signals; (b) the one or more third electrical audio signals; or (c) the one or more fourth electrical audio signals.

14. The portable mixer of claim 12, further comprising:
a second electrical output connector electrically coupled to the audio processing component and configured to provide the one or more output signals to headphones; and
a speaker electrically coupled to the audio processing component.

15. The portable mixer of claim 12, wherein:
the audio processing component comprises:
a limiter;
a high pass filter;
an analog-to-digital converter level;
a first gain control mechanism configured to apply a first gain to a first signal of the one or more intermediary signals; and
a second gain control mechanism configured to apply a second gain to a second signal of the one or more intermediary signals.

16. The portable mixer of claim 12, wherein:
the first microphone is rotatable relative to a first axis parallel to the first side; and
the second microphone is rotatable relative to a second axis parallel to the second side.

17. The portable mixer of claim 16, wherein:
the first microphone is rotatable at least one hundred and fifty degrees around the first axis; and
the second microphone is rotatable at least one hundred and fifty degrees around the second axis.

18. The portable mixer of claim 16, wherein:
the first and second axes are collinear with each other.

19. A method of forming an audio receiving device configured to couple to and produce an output signal for a portable media device, the method comprising:
providing a housing with a first exterior side and a second exterior side;
providing a first microphone;
securing the first microphone to the first exterior side of the housing such that the first microphone can be rotated relative to the first exterior side of the housing;
providing a second microphone;
securing the second microphone to the second exterior side of the housing such that the second microphone can be rotated relative to the second exterior side of the housing;
providing an audio processing component;
providing a control component;
electrically coupling the first microphone and the second microphone to the audio processing component;
electrically coupling the control component to the audio processing component;
securing the audio processing component and the control component inside the housing;
providing an electrical output connector; and
electrically coupling the electrical output connector to the audio processing component, where the electrical output connector is configured to be coupled to the portable media device.

20. The method of claim 19, further comprising:
providing a first input connector;
electrically coupling the first input connector to the audio processing component;
securing the first input connector to the housing;
providing a second input audio connector;
electrically coupling the second input connector to the audio processing component; and
securing the second input connector to the housing.

21. The method of claim 19, further comprising:
providing the housing comprises:
providing the housing with the second exterior side opposite the first exterior side.

22. The method of claim 19, wherein:
securing the first microphone comprises:
securing the first microphone to the first exterior side of the housing such that the first microphone can be rotated at least a hundred and fifty degrees around the first side of the housing; and
securing the second microphone comprises:
securing the second microphone to the second exterior side of the housing such that the second microphone can be rotated at least a hundred and fifty degrees around the second side of the housing.

23. The method of claim 19, wherein:
electrically coupling the first microphone and the second microphone to the audio processing component;
electrically coupling the control component to the audio processing component; and
securing the audio processing component and the control component occur simultaneously with each other.
